(19) United States
(12) Patent Application Publication
(10) Pub. No.: US 2016/0368416 A1
(43) Pub. Date: Dec. 22, 2016

(54) Awareness Lights

(71) Applicants: Brenda L. Nemitz, Van Dyke, WI (US); Zachary E. Vande Kolk, Van Dyke, WI (US)

(72) Inventors: Brenda L. Nemitz, Van Dyke, WI (US); Zachary E. Vande Kolk, Van Dyke, WI (US)

(21) Appl. No.: 14/741,559

(22) Filed: Jun. 17, 2015

(51) Int. Cl. B60Q 1/50; B60Q 7/00; H05B 33/08; B60Q 1/26; B60Q 1/00

(52) U.S. Cl. CPC B60Q 1/50; B60Q 1/2696; B60Q 1/0076; H05B 33/0863; B60Q 1/268; B60Q 7/00

(57) ABSTRACT

A lighting system for interior lights of an automobile and visible outside the automobile comprising: a panel located on the windshield of the automobiles wherein said panel is a light panel comprises of base, mounting means, cover, and warning signal lights; visual aid for assistance/warning wherein said aid is multiple lights displayed for different warning signals; button/switch for activating light fixtures; a multiple row, single source, or an array of light emitting diode light sources configured on a light support wherein said light supports are in plurality or are solitary light sources; a controller, wherein the said LED source is in electrical communication with said controller; wires connected to a fuse box and a control box; and a power supply wherein said source is a battery, or other electrical source. The switch on the displayed LED provided at the windshield is used to change lights according to the color coding of lights; wherein yellow light indicating caution, slow down, something obstructing or in the roadway, red light indicating stopping needs assistance for the reasons like flat tires, vehicle stalled etc, blue light indicating needs medical assistance.

### CROSS REFERENCE TO RELATED APPLICATIONS

Not applicable,

### FEDERALLY SPONSORED RESEARCH AND DEVELOPMENT

Not applicable.

### MICROFICHE

Not applicable

### BACKGROUND OF THE INVENTION

(1) Field of the Invention

The invention relates to an electronic display board, in particular, relates to a safety alert multifunctional electronic display board. Further this invention is related to a hazard sign for automobiles and to an indicator with a display screen lit with subdued and warning colored lights.

(2) Background

Dashboards, particularly those of motor vehicles, more and more often comprise a display screen, for example a screen of the LCD (Liquid Crystal Display) type, on which information texts or icons for the driver appear. This screen is backlit by lighting sources, for example light-emitting diodes (LEDs), distributed in a matrix.

Light bars or emergency lights of the type used on emergency vehicles such as fire trucks, police cars, and ambulances, utilize warning signal lights to produce a variety of light signals. These light signals involve the use of various colors and patterns. Generally, these warning signal lights consist of incandescent and halogen light sources having reflective back support members and colored filters.

Many problems exist with the known methods for producing warning light signals. One particular problem with known light sources is their reliance on mechanical components to revolve or oscillate the lamps to produce the desired light signal. Additionally, these components increase the size of the light bar or emergency lights which may adversely affect the vehicles aerodynamic characteristics. Moreover, because of the relatively poor reliability of conventional lighting and the complexity of the present strobe rotational systems, there is an increased likelihood that a breakdown of the light bar or light source will occur requiring the repair or replacement of the defective component. Finally, conventional light bars and light sources require a relatively large amount of electrical current during operation. The demands upon the electrical power system for a vehicle may therefore exceed available electrical resources, reducing optimization of performance or worse, generating a potential hazard form shorted or over heated systems.

Halogen lamps or gaseous discharge xenon lamps generally emanate large amounts of heat which are difficult to dissipate from a sealed light enclosure or emergency light and which may damage the electronic circuitry contained therein. In addition, these lamps consume large amounts of current requiring a large power supply, battery, or electrical source which may be especially problematic for use with a vehicle. These lamps also generate substantial electromagnetic emissions, which may interfere with radio communications for a vehicle. Finally, these lamps, which are not rugged, have relatively short life cycles necessitating frequent replacement.

Another problem with the known warning signal lights is the use of filters to produce a desired color. Filtering techniques produce more heat that must be dissipated. Moreover, changing the color of a light source requires the physical removal of the filter from the light source or emergency light and the replacement with a new filter. Furthermore, filters fade or flake over time rendering the filters unable to consistently produce a desired color for observation in an emergency situation.

Electronic display boards are safety tips in the multiple industries important tool currently used electronic display board is mainly used as a display LED digital tube body, through a simple circuit board is connected to the Settings button to display the desired production the number of days of production safety and other content.

LEDs are more and more used in automotive lighting. LEDs are now found in lighting modules of cars that were previously exclusively reserved for filament light bulbs. A third (central) brake light in vehicles is now commonly implemented with LED technology, and it is expected that LEDs will in future be used for all light units.

The efficiency, durability and small form factor of LEDs is particularly attractive for car lighting modules.

Currently, the rear light module of a car for the European market typically contains four different segments with distinctive colors:

(1) main rear light—red,

(2) reversing light—white,

(3) indicator—orange, and

(4) break light—red.

The conventional light source in this lighting fixture is the filament light bulb, and to create the correct light color, the light covers are made of colored plastic. This simple design of car rear light is inefficient in term of light generation because the filament light bulb is inefficient (luminous efficacy of less than 4%), and the use of a color filter further reduces the light flux to the outside.

When LEDs are designed in a car rear light module, a color LED (red/orange/white) is used in combination with clear light module cover. This new design offers not only a new look to the car, but also a better lighting efficiency. However, the use of a specific color LED for a specific segment of the rear light module has two disadvantages. Firstly, the light sources of different segments of the rear light module are not interchangeable posing a logistic problem.

Secondly, despite the tong lifetime of LEDs, failure can ultimately occur to one of the signal lights. As for conventional filament lights, the failed lighting unit will be out of service posing a serious safety risk to the car driver and passengers.

According to the invention, there is provided a lighting system for interior lights of an automobile, but visible outside the vichle comprising:

A panel located on the windshield of the automobiles;
Visual aid for assistance warning;
Button/switch for activating light fixtures;
Multiple lights displayed for different warnings.

### BRIEF SUMMARY OF THE INVENTION

According to the invention, there is provided a light emitting diode (LED) warning signal light which may be depicted in several embodiments. In general, the warning signal light may be formed of a multiple row, single source, or an array of light emitting diode light sources configured on a light support and in electrical communication with a controller and a power supply, battery, or other electrical source. The warning signal light may provide various light signals, colored light signals, for use in association with a vehicle or by an individual. The warning signal light may also be easily transportable and may be conveniently connected to a stand such as a tripod for electrical coupling to a power supply, battery, or other electrical source as a remote stand-alone signaling device.

The controller is in electrical communication with the power supply and the LED's to display the desired color light from the LED light sources for the provision of a desired type of warning light effect. Each individual light support may be positioned adjacent to, and be in electrical communication with, another light support through the use of suitable electrical connections. A plurality of light supports or solitary light sources may be electrically coupled in either a parallel or series manner to the controller. The controller is also preferably in electrical communication with the power supply and the LED's, to regulate or modulate the light intensity of the LED light sources for variable illumination of the LED light sources as observed by an individual.

A light bar may also be provided having one or more longitudinal supports or bars and/or one or more elevated pod illumination elements. Each pod illumination element may be raised with respect to a light bar by one or more supports which extend upwardly from the base. The pod illumination elements may alternatively be oval or circular in shape. The light bar may also include one or more longitudinal light elements integral to the base which extend transversely to the roof of an emergency vehicle.

The principal advantage of the present invention is that the warning signal light is capable of producing three different types of light warning signals.

Another principal advantage of the present invention is to be rugged and to have a relatively longer life cycle than traditional warning signal lights.

Still another principal advantage of the present invention is to allow the user to change the color of the light signal without having to make a physical adjustment to the light source from the colored panel.

Still another principal advantage of the present invention is the provision of an LED light source which is formed of a relatively simple and inexpensive design, construction, and operation and which fulfills the intended purpose without fear of failure or risk of injury to persons and/or damage to property.

Still another principal advantage of the present invention is the provision of an LED light source which produces brilliant lighting in any of the three colors associated with vehicle light signal such as red, blue, yellow.

Other objectives of the invention will become apparent to those skilled in the art once the invention has been shown and described. These objectives are not to be construed as limitations of applicant's invention, but are merely aimed to suggest some of the many benefits that may be realized by the apparatus of the present application and with its many embodiments.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

To The drawings constitute a part of this specification and include exemplary embodiments of the invention, which may be embodied in various forms. It is to be understood that in some instances various aspects of the invention may be shown exaggerated or enlarged to facilitate an understanding of the invention.

FIG. 1 is a perspective view of the awareness lights according to a preferred embodiment of the present invention.

FIG. 2 depicts the invention inside the car.

### DETAILED DESCRIPTIONS OF THE INVENTION

The In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural, logical and electrical changes may be made without departing from the spirit and scope of the present invention. The following detailed description is, therefore, not to be taken in a limiting sense, and the scope of the present invention is defined by the appended claims and their equivalents.

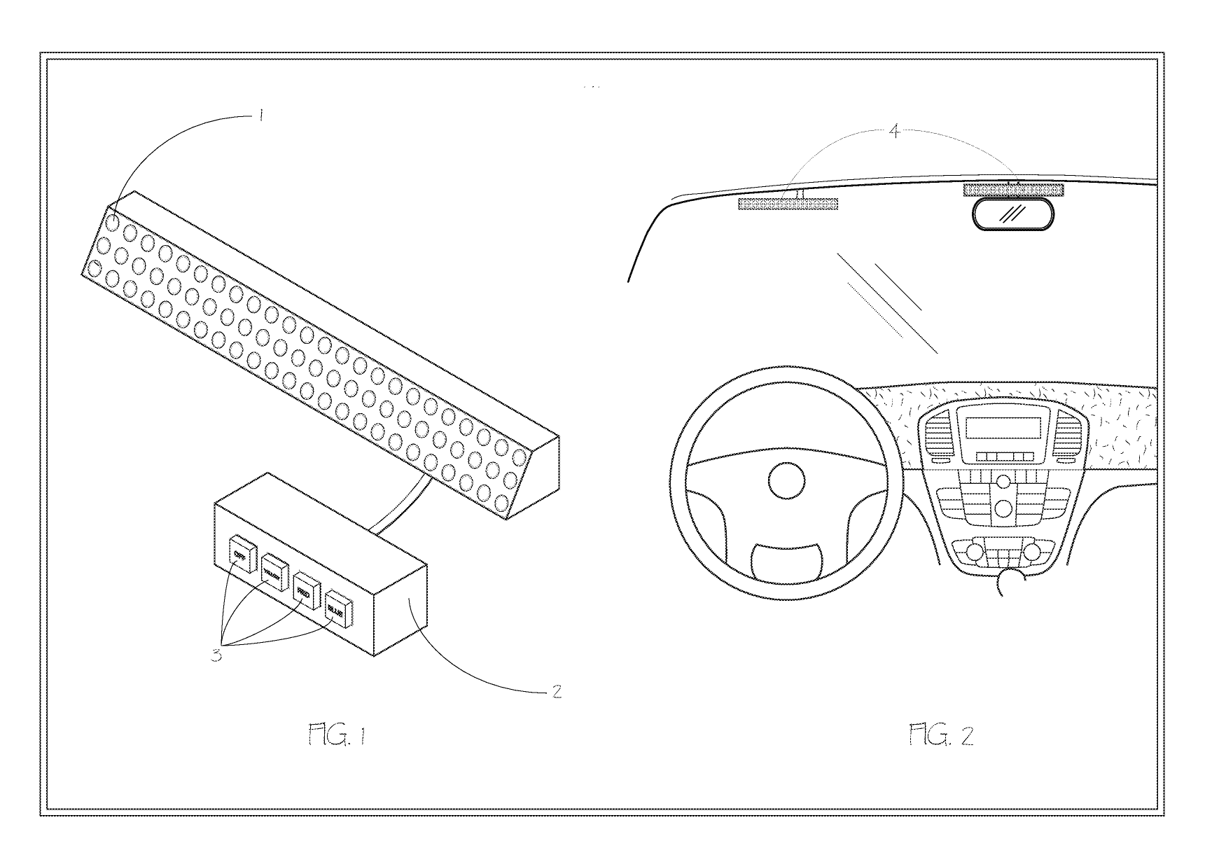

A warning signal light according to the principles of the invention is indicated generally herein as numeral FIG. 1 depict light bar/panel mounted to an ordinary vehicle. Light panel includes base, mounting means, cover, and warning signal lights.

The panel 1 is a 8″ long plastic, having LED lights 2 and wire attached to a rectangular box which lead to a switch or sets of buttons 3 that are used to control the lights. The driver/individual can switch on the displayed LED provided at the windshield, and change lights according to the color coding of lights and according to the message to be conveyed through the LEDs. For example:

Yellow light for caution, slow down, something obstructing or in the roadway.
Red light for stopping needs assistance for the reasons like flat tires, vehicle stalled etc.
Blue light indicating needs medical assistance.

Referring to FIG. 1, warning signal light comprises, light sources, controller, and connecting portion for attaching the warning signal light to light bar panel. The warning signal light operates to create a warning signal for use by a vehicle by selectively activating light sources using a controller. Alternatively, warning signal light may be formed of a solitary LED light source at the discretion of an individual.

As illustrated in the FIG. 1 “0” denotes LED bulbs that are placed at the ratio of 9 bulbs per inch, capable of changing to three different colors. In a preferred embodiment of the current invention that the three colors displayed in the choice of the driver/person in the car include Red, Yellow, Blue. The colors used are self-indicative about the message generated by the user to the people who see the vehicle from the front. The colors are for

Yellow light for caution, slow down, something obstructing or in the roadway.
Red light for stopping, needs assistance for the reasons like flat tires, vehicle stalled etc.
Blue light indicating needs medical assistance.

The battery source is 12 volts and the front piece would be made up made with bottom angled out to allow for the angle of the windshield to allow light to reflect straight.

The FIG. 1 also shows the side view of the invention. The illustration in FIG. 2 shows the location of the LED lights with respect of the windshield. The current invention could display light bar above the rear view mirror or left hand corner and similarly for back window (top, middle or left side). The wire used in the current invention is 12′ wire for the back window. The said wire is then connected to a fuse box and a control box by using a Velcro to the left side of the dash, wherein the front and back lights are connected to the same control box. The FIG. 1 also displays a control box in the current invention.

Light sources are preferably light emitting diodes (LED's) and are generally arranged in aligning columns and rows as shown in FIG. 1. The controller is used to selectively activate columns and rows. Controller generally comprises microprocessor and circuitry and is preferably contained within, attached to, or an element of, LED support.

The advantages of the current invention include safety of the automobiles as the sign in the current invention will provide automobile owners, highway drivers and law enforcement with the ability to identify an inoperative vehicle, help the owner of the car, prevent accidents on the highways, understand the vehicle problem and help law enforcement contact the owner.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and is improvements fall within the scope of the invention.

We claim:

1. A lighting system for interior lights of an automobile, comprising:
a panel located on the windshield of the automobiles;
visual aid for assistance/warning wherein said aid is multiple lights displayed for different warning signals;
a button/switch for activating light fixtures;
a multiple row, single source, or an array of light emitting diode light sources configured on a light support wherein said light supports are in plurality or are solitary light sources;
a controller, wherein the said LED source is in electrical communication with said controller;
wires connected to a fuse box and a control box; and
a power supply wherein said source is a battery, or other electrical source.

2. The lighting system for interior lights of claim 1 wherein said panel further comprises:
a base;
mounting means;
ver; and
warning signal lights.

3. The lighting system for interior lights of claim 1 wherein said switch on the displayed LED provided at the windshield is used to change lights based on the color coding of lights;
wherein:
Yellow light indicating caution, slow down, something obstructing or in the roadway.
Red light indicating stopping needs assistance for the reasons like flat tires, vehicle stalled etc.
Blue light indicating needs medical assistance.

4. The lighting system for interior lights of claim 1 wherein said warning signal light is easily transportable and may be conveniently connected to a stand such as a tripod for electrical coupling to a power supply, battery, or other electrical source as a remote standalone signaling device.

5. The lighting system for interior lights of claim 1 wherein said panel is a 8″ long plastic, LED lights, wire attached to a rectangular box which lead to said switch or sets of buttons that are used to control the lights.

6. The lighting system for interior lights of claim 1 wherein said plurality of light supports are electrically coupled in either a parallel or series manner to said controller.

7. The lighting system for interior lights of claim 1 wherein said solitary light sources are electrically coupled in either a parallel or series manner to said controller.

8. The lighting system for interior lights of claim 1 wherein said controller is used to selectively activate columns and rows wherein, controller comprises a microprocessor, circuitry and is contained within, attached to, or an element of, LED support.

9. The lighting system for interior lights of claim 1 wherein said battery source is 12 Volts battery.

10. The lighting system for interior lights of claim 1 wherein said the automobiles front piece would be made up made with bottom angled out to allow for the angle of the windshield and allow light to reflect straight.

11. The lighting system for interior lights of claim 1 wherein said array of light emitting diode are bulbs that are placed at the ratio of 9 bulbs per inch, capable of changing to three different colors.

12. The lighting system for interior lights of claim 1 wherein said panel is a display light bar located above the rear view mirror or left hand corner and similarly for back window (top, middle or left side).

13. The lighting system for interior lights of claim 1 wherein said wire is 12′ wire for the back window.

14. The lighting system for interior lights of claim 1 wherein said wire is connected to said fuse box and said control box by using a Velcro to the left side of the dash, wherein the front and back lights are connected to said control box.

15. The lighting system for interior lights of claim 1 wherein said light bar comprises of one or more longitudinal supports or bars and/or one or more elevated pod illumination elements wherein each pod illumination element may be raised with respect to a light bar by one or more said supports which extend upwardly from the base.

16. The lighting system for interior lights of claim 1 wherein said pod illumination elements may alternatively be oval or circular in shape.

17. The lighting system for interior lights of claim 1 wherein said light bar includes at least one longitudinal light elements integral to the base which extend transversely to the roof of an emergency vehicle.

18. The lighting system for interior lights of claim 1 wherein said lighting system for interior lights of an automobile allows the user to change the color of the light signal without having to make a physical adjustment to said light source from said colored panel.
